(19) United States
(12) Patent Application Publication
(10) Pub. No.: US 2022/0159354 A1
(43) Pub. Date: May 19, 2022

(54) INTERNET OF THINGS LABEL FOR FACTORY AND WAREHOUSE APPLICATIONS

(71) Applicant: The Boeing Company, Chicago, IL (US)

(72) Inventors: John Dalton Williams, Decatur, AL (US); Michael Francis Mitchell, Huntsville, AL (US)

(73) Assignee: The Boeing Company, Chicago, IL (US)

(21) Appl. No.: 17/399,809

(22) Filed: Aug. 11, 2021

Related U.S. Application Data
(60) Provisional application No. 63/113,795, filed on Nov. 13, 2020.

(51) Int. Cl. H04Q 9/00; H04L 29/08

(52) U.S. Cl. CPC H04Q 9/00; H04L 67/26; H04Q 2209/75; H04Q 2209/84; H04Q 2209/40

(57) ABSTRACT

Systems, apparatuses and methods may provide for label technology that includes a flexible substrate and a flexible circuit coupled to the flexible substrate, the flexible circuit including a power source, a microcontroller, a plurality of sensors, one or more transceivers, and an antenna. The microcontroller may be configured to identify sensor readings in one or more signals from the plurality of sensors and send the sensor readings to one or more of a central computer or a computer network via one or more standard wireless transmission protocols, wherein at least one of the sensor readings is sent in a push communication.

### CROSS-REFERENCE TO RELATED APPLICATIONS

This U.S. Non-provisional patent application claims the benefit of priority to U.S. Provisional Patent Application No. 63/113,795 filed Nov. 13, 2020.

### TECHNICAL FIELD

Embodiments generally relate to object labeling. More particularly, embodiments relate to an Internet of Things (IoT) label for factory and warehouse applications.

### BACKGROUND

Traditional tracking of objects within factories may be heavily reliant on manual processes, which can be costly and time consuming. While more recent smart tracking solutions may have reduced the reliance on manual processes, there remains considerable room for improvement. For example, passive technology such as RFID (radio frequency identifier) tags or NFC (near field communications) modules may provide for only intermittent tracking in response to an interrogation of the passive device. Moreover, active technology may have an insufficient communications infrastructure and a form factor (e.g., rigid printed circuit board placed in a traditional plastic enclosure) that limits the technology to tracking large bulk items (e.g., pallets). Additionally, conventional passive and active tracking solutions may be vulnerable to package tampering.

### SUMMARY

In accordance with one or more embodiments, a label comprises a flexible substrate and a flexible circuit coupled to the flexible substrate, the flexible circuit including a power source, a microcontroller, a plurality of sensors, one or more transceivers, and an antenna, wherein the microcontroller is to identify sensor readings in one or more signals from the plurality of sensors and send the sensor readings to one or more of a central computer or a computer network via one or more standard wireless transmission protocols, wherein at least one of the sensor readings is sent in a push communication.

In accordance with one or more embodiments, a method of operating a microcontroller comprises identifying sensor readings in one or more signals from a plurality of sensors in a flexible label and sending the sensor readings to one or more of a central computer or a computer network via one or more standard wireless transmission protocols, wherein at least one of the sensor readings is sent in a push communication.

In accordance with one or more embodiments, a method of fabricating a label comprises coupling a flexible circuit to a flexible substrate, the flexible substrate including a power source, a microcontroller, a plurality of sensors, one or more transceivers, and an antenna, and programming the microcontroller to identify sensor readings in one or more signals from the plurality of sensors, and send the sensor readings to one or more of a central computer or a computer network via one or more standard wireless transmission protocols, wherein at least one of the sensor readings is sent in a push communication.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a communications architecture for a flexible label according to an embodiment;

FIG. 2 is an illustration of multiple examples of 3D (three-dimensional) sensor geometries according to embodiments;

FIG. 3 is a side view of an example of a flexible label according to an embodiment;

FIG. 4 is a block diagram of an example of a flexible circuit according to an embodiment;

FIG. 5 is an illustration of an example of a deployment of flexible labels in a warehouse application according to an embodiment;

FIG. 6 is a flowchart of an example of a method of operating a microcontroller according to an embodiment;

FIG. 7 is a flowchart of an example of a method of reprogramming a microcontroller according to an embodiment; and

FIG. 8 is a flowchart of an example of a method of fabricating a label according to an embodiment.

### DESCRIPTION OF EMBODIMENTS

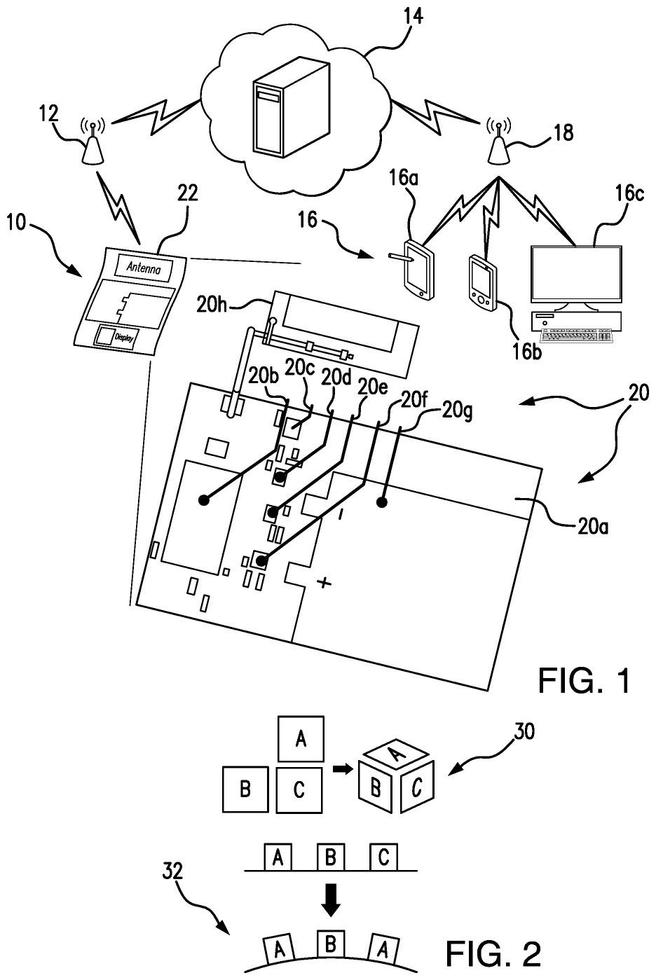

Turning now to FIG. 1, an IoT communications architecture is shown in which a flexible label 10 wirelessly communicates sensor readings via a cellular network 12 to a computer network 14 (e.g., including a cloud computing infrastructure and/or cloud server). In an embodiment, the computer network 14 communicates with one or more remote devices 16 (16a-16c, e.g., central computers) via a wireless network 18 (e.g., operating on a cellular or other wireless protocol). As will be discussed in greater detail, the flexible label 10 may include a flexible circuit 20 (20a-20h) coupled to a flexible substrate 22 (e.g., polymer with an adhesive backing). In one example, the flexible circuit 20 includes a flexible printed circuit board (PCB) 20a (e.g., containing electrical traces printed on one or both sides), a microcontroller 20b, a motion sensor 20c (e.g., accelerometer that detects shock, vibration and/or tampering), an ultraviolet (UV) light sensor 20d, a UV index (e.g., visible light) sensor 20e, an environmental sensor 20f (e.g., having temperature, relative humidity and/or pressure sensing capabilities), a flexible power source such as a battery 20g, and an antenna 20h.

The microcontroller 20b may be programmed to identify sensor readings in one or more signals (e.g., temperature signals, relative humidity/RH signals, location signals, motion signals, etc.) from the sensors 20c-20f and send the sensor readings to the computer network 14, a tablet device 16a, a smart phone 16b and/or a workstation 16c. Of particular note is that one or more of the sensor readings may be sent in a push communication that is not in response to a request or interrogation from an external device. Rather, the microcontroller 20b may generate the push communication in accordance with a programmable time interval, in response to an event associated with the sensor readings, etc., or any combination thereof. For example, the event might correspond to a temperature measurement crossing a temperature threshold, a humidity measurement crossing a humidity threshold, a vibration event, an impact event, a tampering event, and so forth. With respect to the programmable time interval, the microcontroller 20b may extend battery life by powering down when not communicating with the sensors 20c-20f or the computer network 14. The illustrated flexible label 10 is therefore enhanced relative to conventional active, passive and manual solutions at least to the extent that it enables proactive tracking, a robust communications infrastructure, the ability to track relatively small items/assets and/or less vulnerability to package tampering.

Indeed, the label 10 may be useful in applications outside the warehouse/factory context. For example, the label 10 might be used to monitor the state of household objects such as a coffee mug (e.g., monitoring surface temperature and/or condensation), tools such as a drill (e.g., monitoring oscillation frequency and/or strength over time), and so forth.

FIG. 2 shows a 3D sensor geometry 30 in which a first sensor (sensor “A”) is placed on a first surface of an object (e.g., in the x-plane), a second sensor (sensor “B”) is placed on a second surface of the object (e.g., in the y-plane), and a third sensor (sensor “C”) is placed in a third surface of the object (e.g., in the z-plane). In an embodiment, the sensors A, B and C are incorporated into a flexible label such as the flexible label 10 (FIG. 1), already discussed. Similarly, another 3D sensor geometry 32 may include a first sensor (sensor “A”), a second sensor (sensor “B”), and a third sensor (sensor “C”) that are placed on a curved surface of an object. The 3D sensor geometries 30, 32 therefore demonstrate the form factor advantages of flexible sensors as described herein.

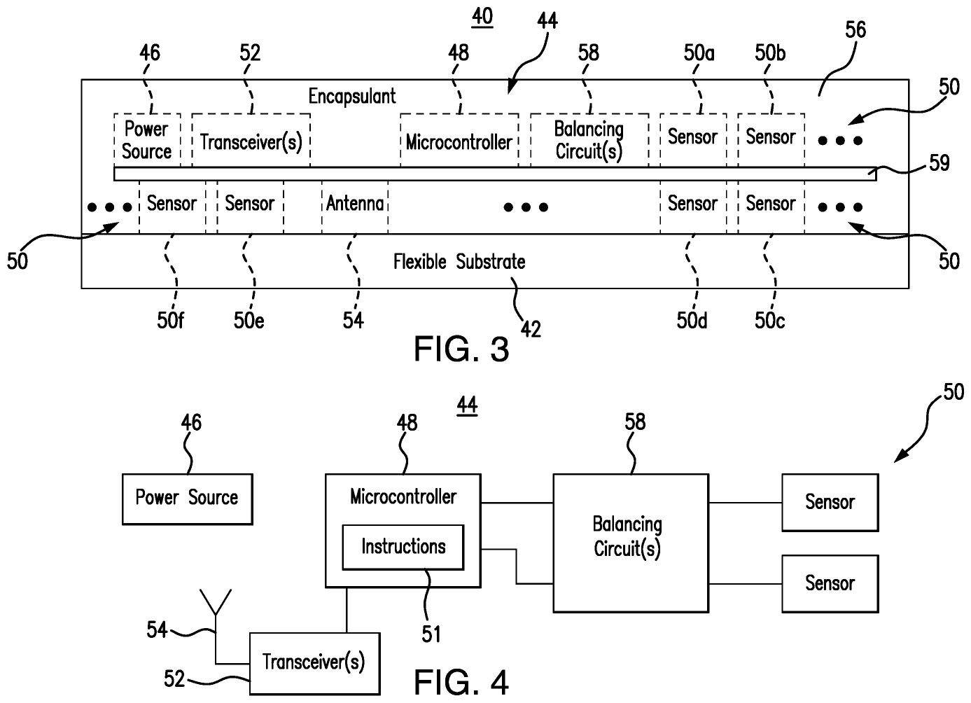

Turning now to FIG. 3, a label 40 is shown. The illustrated label 40, which may be readily substituted for the label 10 (FIG. 1), already discussed, includes a flexible substrate 42 (e.g., with a “peel and stick”) backing and a flexible circuit 44 coupled to the flexible substrate 42. In an embodiment, the flexible circuit 44 includes a power source 46, a microcontroller 48, a plurality of sensors 50 (50a-50f), one or more transceivers 52, and a flexible antenna 54. As already noted, the microcontroller 48 may be programmed to identify sensor readings in one or more signals from the plurality of sensors 50 and send the sensor readings to one or more of a central computer or a computer network via one or more standard wireless transmission protocols.

For example, the one or more signals may include a temperature signal (e.g., containing a temperature measurement), a relative humidity signal (e.g., containing a humidity measurement), a location signal (e.g., containing a location measurement based on triangulation or other suitable technology), a motion signal (e.g., containing a motion measurement), etc. In an embodiment, at least one of the sensor readings indicates one or more of a temperature measurement crossing a temperature threshold (e.g., exceeding an upper temperature threshold or falling below a lower temperature threshold), a humidity (e.g., RH) measurement crossing a humidity threshold (e.g., exceeding an upper humidity threshold or falling below a lower humidity threshold), a vibration event (e.g., during vehicle transit), an impact event (e.g., during warehouse storage), a tampering event (e.g., attempted removal), etc., or any combination thereof. Additionally, the microcontroller 48 may generate the push communication in response to an event (e.g., temperature, humidity, vibration, impact and/or tampering event) associated with the sensor readings. In one example, the microcontroller 48 generates the push communication in accordance with a programmable time interval (e.g., every thirty seconds to five minutes). At least one of the sensor readings may also be sent in response to a request (e.g., interrogation).

The illustrated label 40 also includes an encapsulant 56 to provide environmental protection to the flexible circuit 44. Accordingly, the label 40 may withstand broad temperature ranges within warehouse environments as well as the vibration and shot typical of current package handling practices. In one example, the power source 46 is replaceable. Additionally, the power source 46 may be rigid or flexible, depending on the circumstances.

In an embodiment, the microcontroller 48 encrypts the sensor readings prior to transmission (e.g., data is encrypted in motion). In such a case, the sensor readings may be sent to the central computer and/or the computer network via an identity verified network communication link to further protect against tampering. Additionally, software trust may be verified at a hardware level to protect against software binary and configuration compromises. The standard wireless transmission protocols may include a cellular IoT protocol, a wireless protocol, an ultra-wideband (UWB) protocol, a BLUETOOTH low energy (BLE) protocol, a wireless mesh network protocol, a 5G (fifth generation) network protocol (e.g., 5G New Radio/NR), a wireless network communication protocol, a cellular network communication protocol, etc., or any combination thereof.

In the illustrated example, the flexible circuit 44 includes a flexible PCB 59. The flexible PCB 59 may include laser cut vias (not shown) and electrical traces (not shown) printed on both sides of the flexible PCB 59. Although the illustrated sensors 50 are mounted to the flexible PCB 59, additional external sensors may also be connected to the flexible PCB 59 via a multi-wire interface such as, for example, an I²C (inter-integrated circuit), I²S (inter-integrated chip sound) and/or SPI (serial peripheral interconnect) interface. In an embodiment, the flexible circuit 44 also includes one or more balancing circuits 58 to ensure that the signal lines between the microcontroller 48 and the sensors 50 are of a matched impedance. The balancing circuits 58 may be in the form of passive components, active (e.g., requiring power) or passive packaged parts, or alternatively be incorporated into the microcontroller 48.

FIG. 4 demonstrates that the microcontroller 48 may include one or more instructions 51, which when executable by the microcontroller 48, cause the microcontroller 48 to identify sensor readings in one or more signals from the plurality of sensors 50 and send the sensor readings to one or more of a central computer or a computer network via one or more standard wireless transmission protocols. As already noted, at least one of the sensor readings may be sent in a push communication.

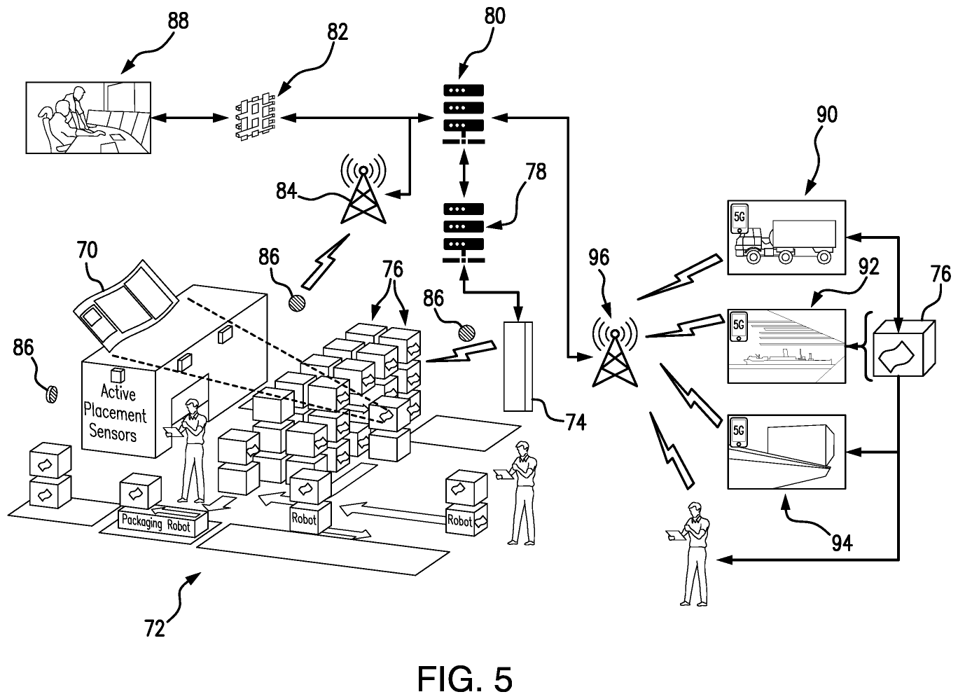

FIG. 5 shows an environment in which secure IoT labels such as a label 70 are mounted to various packages 76 in an automated warehouse 72. In an embodiment, the label 70 is similar to the label 10 (FIG. 1) and/or the label 40 (FIG. 3), already discussed. The label 70 may send push communications to a directional antenna 74 such as, for example, a large multiple input multiple output (MIMO) signal collection antenna that improves connectivity and provides a tracking resolution on the order of 0.15 meters (6 inches). In one example, the directional antenna 74 communicates with a cellular (e.g., LTE-M (Long Term Evolution Category Mobile1), LTE NB-IoT (Narrow Band Internet of Things), or 5G New Radio) core system 78, which in turn communicates with a cellular secure authentication (SA) core system 80 (e.g., enforcing zero trust mobile constraints and/or identity verified network communication links). For example, the identity verified network communication links may involve a trust handshake protocol between the cellular SA core system 80 and the cellular core system 78 (e.g., non-SA). In an embodiment, the cellular SA core system 80 also communicates with an accountable property system of record APSR 82 and an antenna 84 that receives signals from one or more cameras 86 that are mounted within the automated warehouse 72, allowing for visual imagery data to be added to the APSR. Accordingly, warehouse operations personnel 88 may be automatically alerted to conditions such as a temperature measurement crossing a temperature threshold, a humidity measurement crossing a humidity threshold, a vibration event, an impact event, a tampering event, visual imagery, and so forth.

Indeed, the label 70 may enhance incoming and outgoing logistics by enabling localized data collection in trucks 90, shipyard docks 92, and containers 94. In such a case, slicing may be used in a 5G RAN (radio access network) 96. More particularly, the original network architecture may be expanded and potentially “sliced” across different frequency bands in multiple logical and independent networks that are configured to effectively meet various service requirements. In an embodiment, the following techniques are employed:
Network functions express elementary network functionalities that are used as “building blocks” to create every network slice;
Virtualization provides an abstract representation of the physical resources under a unified and homogeneous scheme and enables a scalable slice deployment relying on NFV (network function virtualization), where each network function instance is decoupled from the network hardware running the instance;
Orchestration is a process that enables coordination of the different network components that are involved in the life-cycle of each network slice. In this context, SDN (Software-Defined Networking) may be used to enable a dynamic and flexible slice configuration.

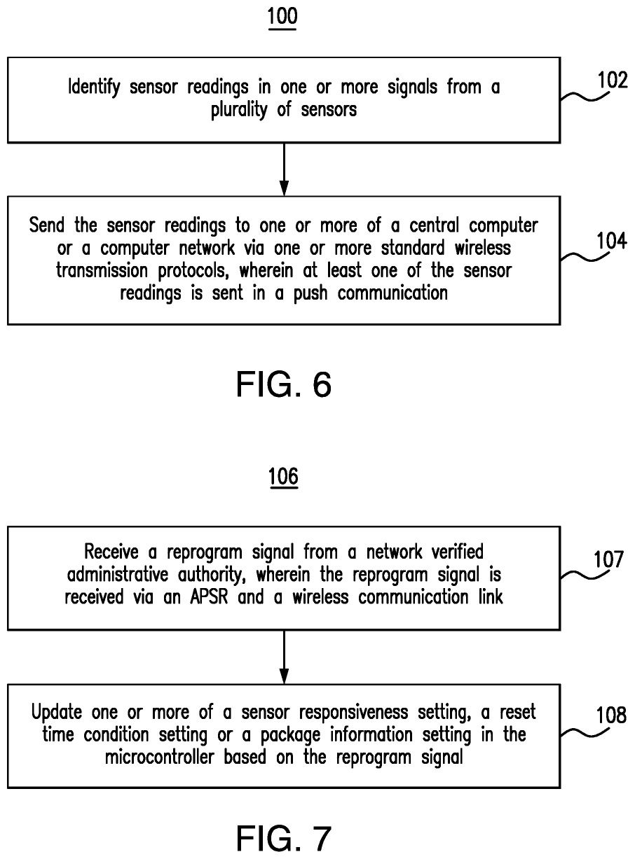

FIG. 6 shows a method 100 of operating a microcontroller. The method 100 may generally be implemented in a microcontroller such as, for example, the microcontroller 20b (FIG. 1) and/or the instructions 51 of the microcontroller 48 (FIGS. 3 and 4), already discussed. More particularly, the method 100 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

Illustrated processing block 102 provides for identifying sensor readings in one or more signals from a plurality of sensors in a flexible label. The sensor readings may indicate, for example, a temperature measurement crossing a temperature threshold, a humidity measurement crossing a humidity threshold, a vibration event, an impact event, a tampering event, etc., or any combination thereof. Block 102 may include comparing measurements to thresholds (e.g., programmable thresholds) and/or detecting one or more warning messages in the signal(s) (e.g., with the sensors performing the comparisons).

Block 104 may provide for sending the sensor readings to one or more of a central computer or a computer network via one or more standard wireless transmission protocols such as, for example, a cellular IoT protocol, a wireless protocol, a UWB protocol, a BLE protocol, a wireless mesh network protocol, a 5G network protocol, a wireless network communication protocol, a cellular network communication protocol, and so forth. In the illustrated example, at least one of the sensor readings is sent in a push communication. Alternatively, the sensor readings may be sent over a wired link.

The push communication may be generated in multiple ways. For example, the push communication may be generated in response to an event (e.g., temperature event, humidity event, motion event, vibration event, impact event) associated with the sensor readings. Additionally, the push communication may be generated in accordance with a programmable time interval (e.g., periodically). In an embodiment, at least one of the sensor readings is sent in response to a request. In one example, block 104 also provides for encrypting the sensor readings, wherein the encrypted sensor readings are sent to the central computer and/or computer network via an identity verified network communication link. The illustrated method 100 therefore enhances performance at least to the extent that it enables proactive tracking, a robust communications infrastructure, the ability to track relatively small items and/or less vulnerability to package tampering.

FIG. 7 shows a method 106 of reprogramming a microcontroller such as, for example, the microcontroller 20b (FIG. 1) and/or the instructions 51 of the microcontroller 48 (FIGS. 3 and 4), already discussed. The method 106 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 107 provides for receiving a reprogram signal from a network verified administrative authority, wherein the reprogram signal is received via an APSR and a wireless communication link. In an embodiment, block 108 updates one or more of a sensor responsiveness setting, a reset time condition setting or a package information setting in the microcontroller based on the reprogram signal.

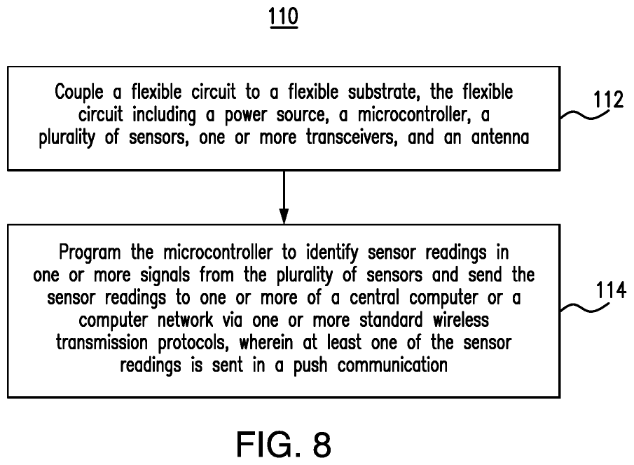

FIG. 8 shows a method 110 of fabricating a label such as, for example, the label 10 (FIG. 1), the label 40 (FIG. 3) and/or the label 70 (FIG. 5). The method 110 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 112 provides for coupling a flexible circuit to a flexible substrate, where the flexible circuit includes a power source, a microcontroller, a plurality of sensors, one or more transceivers, and an antenna. In an embodiment, the plurality of sensors include a temperature sensor, a relative humidity sensor, a location sensor, and a motion sensor (e.g., to detect vibration, shock, tampering, etc.). One or more of the sensors may also be combined into a shared package (e.g., combined temperature and RH sensor). In one example, the flexible circuit further includes a flexible PCB and one or more balancing circuits. Additionally, block 112 may further include laser cutting vias in the flexible PCB, printing electrical traces on the flexible PCB, and molding an encapsulant substantially around the flexible circuit.

Block 114 may provide for programming the microcontroller to identify sensor readings in one or more signals from the plurality of sensors and send the sensor readings to one or more of a central computer or a computer network via one or more standard wireless transmission protocols. In the illustrated example, at least one of the sensor readings is to be sent in a push communication. The illustrated method 110 therefore produces a label that enables proactive tracking, a robust communications infrastructure, the ability to track relatively small items and/or less vulnerability to package tampering.

### Additional Notes and Examples

Example one includes a label comprising a flexible substrate, and a flexible circuit coupled to the flexible substrate, the flexible circuit including a power source, a microcontroller, a plurality of sensors, one or more transceivers, and an antenna, wherein the microcontroller is to: identify sensor readings in one or more signals from the plurality of sensors, and send the sensor readings to one or more of a central computer or a computer network via one or more standard wireless transmission protocols, wherein at least one of the sensor readings is sent in a push communication.

Example two includes the label of Example one, wherein the sensor readings are to indicate one or more of a temperature measurement crossing a temperature threshold, a humidity measurement crossing a humidity threshold, a vibration event, an impact event or a tampering event.

Example three includes the label of Example one, wherein the microcontroller is to generate the push communication in response to an event associated with the sensor readings.

Example four includes the label of Example one, wherein the microcontroller is to generate the push communication in accordance with a programmable time interval.

Example five includes the label of Example one, wherein at least one of the sensor readings are sent in response to a request.

Example six includes the label of Example one, wherein the one or more signals include a temperature signal, a relative humidity signal, a location signal and a motion signal.

Example seven includes the label of Example one, further including an encapsulant substantially surrounding the flexible circuit.

Example eight includes the label of Example one, wherein the microcontroller is to encrypt the sensor readings, and the encrypted sensor readings are to be sent to one or more of the central computer or the computer network via an identity verified network communication link.

Example nine includes the label of Example one, wherein the standard wireless transmission protocols include one or more of a cellular Internet of Things (IoT) protocol, a wireless protocol, an ultra-wideband protocol, a BLUETOOTH low energy protocol, a wireless mesh network protocol, a 5G network protocol, a wireless network communication protocol, or a cellular network communication protocol.

Example ten includes the label of Example one, wherein the flexible circuit further includes a flexible printed circuit board and one or more balancing circuits.

Example eleven includes a method of operating a microcontroller, the method comprising identifying sensor readings in one or more signals from a plurality of sensors in a flexible label, and sending the sensor readings to one or more of a central computer or a computer network via one or more standard wireless transmission protocols, wherein at least one of the sensor readings is sent in a push communication.

Example twelve includes the method of Example eleven, wherein the sensor readings indicate one or more of a temperature measurement crossing a temperature threshold, a humidity measurement crossing a humidity threshold, a motion event, a vibration event, an impact event or a tampering event.

Example thirteen includes the method of Example eleven, further including generating the push communication in response to an event associated with the sensor readings.

Example fourteen includes the method of Example eleven, further including generating the push communication in accordance with a programmable time interval.

Example fifteen includes the method of Example eleven, wherein at least one of the sensor readings are sent in response to a request.

Example sixteen includes the method of Example eleven, further including encrypting the sensor readings, wherein the encrypted sensor readings are sent to one or more of the central computer or the computer network via an identity verified network communication link.

Example seventeen includes the method of Example eleven, wherein the standard wireless transmission protocols include one or more of a cellular Internet of Things (IoT) protocol, a wireless protocol, an ultra-wideband protocol, a BLUETOOTH low energy protocol, a wireless mesh network protocol, a 5G network protocol, a wireless network communication protocol, or a cellular network communication protocol.

Example eighteen includes the method of Example eleven, further including updating one or more of a sensor responsiveness setting, a reset time condition setting or a package information setting in the microcontroller based on a reprogram signal from a network verified administrative authority, wherein the reprogram signal is received via an accountable property system of record and a wireless communication link.

Example nineteen includes a method of fabricating a label, the method comprising coupling a flexible circuit to a flexible substrate, the flexible circuit including a power source, a microcontroller, a plurality of sensors, one or more transceivers, and an antenna, and programming the microcontroller to identify sensor readings in one or more signals from the plurality of sensors and send the sensor readings to one or more of a central computer or a computer network via one or more standard wireless transmission protocols, wherein at least one of the sensor readings is sent in a push communication.

Example twenty includes the method of Example nineteen, further including molding an encapsulant substantially around the flexible circuit.

Example twenty-one includes the method of Example nineteen, wherein the plurality of sensors include a temperature sensor, a relative humidity sensor, a location sensor and a motion sensor, and wherein the flexible circuit further includes a flexible printed circuit board and one or more balancing circuits.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD (solid state drive)/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A label comprising:
a flexible substrate; and
a flexible circuit coupled to the flexible substrate, the flexible circuit including a power source, a microcontroller, a plurality of sensors, one or more transceivers, and an antenna, wherein the microcontroller is to:
identify sensor readings in one or more signals from the plurality of sensors, and
send the sensor readings to one or more of a central computer or a computer network via one or more standard wireless transmission protocols, wherein at least one of the sensor readings is sent in a push communication.

2. The label of claim 1, wherein the sensor readings are to indicate one or more of a temperature measurement crossing a temperature threshold, a humidity measurement crossing a humidity threshold, a vibration event, an impact event or a tampering event.

3. The label of claim 1, wherein the microcontroller is to generate the push communication in response to an event associated with the sensor readings.

4. The label of claim 1, wherein the microcontroller is to generate the push communication in accordance with a programmable time interval.

5. The label of claim 1, wherein at least one of the sensor readings are sent in response to a request.

6. The label of claim 1, wherein the one or more signals include a temperature signal, a relative humidity signal, a location signal and a motion signal.

7. The label of claim 1, further including an encapsulant substantially surrounding the flexible circuit.

8. The label of claim 1, wherein the microcontroller is to encrypt the sensor readings, and the encrypted sensor readings are to be sent to one or more of the central computer or the computer network via an identity verified network communication link.

9. The label of claim 1, wherein the standard wireless transmission protocols include one or more of a cellular Internet of Things (IoT) protocol, a wireless protocol, an ultra-wideband protocol, a BLUETOOTH low energy protocol, a wireless mesh network protocol, a 5G network protocol, a wireless network communication protocol, or a cellular network communication protocol.

10. The label of claim 1, wherein the flexible circuit further includes a flexible printed circuit board and one or more balancing circuits.

11. A method of operating a microcontroller, the method comprising:
identifying sensor readings in one or more signals from a plurality of sensors in a flexible label; and
sending the sensor readings to one or more of a central computer or a computer network via one or more standard wireless transmission protocols, wherein at least one of the sensor readings is sent in a push communication.

12. The method of claim 11, wherein the sensor readings indicate one or more of a temperature measurement crossing a temperature threshold, a humidity measurement crossing a humidity threshold, a motion event, a vibration event, an impact event or a tampering event.

13. The method of claim 11, further including generating the push communication in response to an event associated with the sensor readings.

14. The method of claim 11, further including generating the push communication in accordance with a programmable time interval.

15. The method of claim 11, wherein at least one of the sensor readings are sent in response to a request.

16. The method of claim 11, further including encrypting the sensor readings, wherein the encrypted sensor readings are sent to one or more of the central computer or the computer network via an identity verified network communication link.

17. The method of claim 11, wherein the standard wireless transmission protocols include one or more of a cellular Internet of Things (IoT) protocol, a wireless protocol, an ultra-wideband protocol, a BLUETOOTH low energy protocol, a wireless mesh network protocol, a 5G network protocol, a wireless network communication protocol, or a cellular network communication protocol.

18. The method of claim 11, further including updating one or more of a sensor responsiveness setting, a reset time condition setting or a package information setting in the microcontroller based on a reprogram signal from a network verified administrative authority, wherein the reprogram signal is received via an accountable property system of record and a wireless communication link.

19. A method of fabricating a label, the method comprising:
coupling a flexible circuit to a flexible substrate, the flexible circuit including a power source, a microcontroller, a plurality of sensors, one or more transceivers, and an antenna; and
programming the microcontroller to identify sensor readings in one or more signals from the plurality of sensors and send the sensor readings to one or more of a central computer or a computer network via one or more standard wireless transmission protocols, wherein at least one of the sensor readings is sent in a push communication.

20. The method of claim 19, further including molding an encapsulant substantially around the flexible circuit.

21. The method of claim 19, wherein the plurality of sensors include a temperature sensor, a relative humidity sensor, a location sensor and a motion sensor, and wherein the flexible circuit further includes a flexible printed circuit board and one or more balancing circuits.
